(19) United States
(12) Patent Application Publication
(10) Pub. No.: US 2015/0037580 A1
(43) Pub. Date: Feb. 5, 2015

(54) PROCESS FOR PREPARING A FILLED POLYMER EXTRUDATE

(71) Applicant: LEISTRITZ EXTRUSIONSTECHNIK GMBH, Nuernberg (DE)

(72) Inventor: Tim RUDERSDORF, NUERNBERG (DE)

(21) Appl. No.: 14/447,013

(22) Filed: Jul. 30, 2014

(30) Foreign Application Priority Data
Jul. 30, 2013 (DE) 10 2013 108 165.7

(51) Int. Cl. B29C 47/06; B29C 47/04; B29C 47/40; B29C 47/08; B29C 47/10; C08J 3/205; B29C 47/00

(52) U.S. Cl. CPC B29C 47/065; C08J 3/2056; B29C 47/043; B29C 47/0066; B29C 47/0898; B29C 47/1081; B29C 47/40; C08J 2323/12; B29L 2009/00
USPC 428/375; 264/173.16; 264/173.18; 264/148; 425/131.1

(57) ABSTRACT

A process for preparing a filled polymer extrudate, with which a flowable composition is made, composed of a carrier fluid and reinforcing agents or filler material (9), or coloring pigments (12 added to them in a first extruder (2) and a polymer melt of a thermoplastic polymer (16) in a second extruder (14, in which the composition and the polymer melt are subsequently co-extruded in a co-extruding step in such a way that the polymer melt encloses the composition forming the core of the generated extrudate strand (22).

The invention relates to a process for preparing a filled polymer extrudate.

It is predominantly in the plastics processing industry that filled polymer extrudates are used as the basis for the production of plastic components, either consisting entirely of plastic or provided with a plastic coating or the like. The polymer extrudate may exist in granular form, for instance as rod-shaped pellets and is commonly melted in an extruder by adding further components and afterwards processed as required, for example by injection molding of the components and the like.

Usually, some mechanical, physical or optical requirements have been defined for the component to be produced, which require the existence of appropriate reinforcing agents or filler materials or color pigments in the component that lend it the desired properties or which are conducive to such properties. Such reinforcing agents or filler materials or color pigments inevitably have to exist in the polymer melt from which the component is manufactured. To ensure the reinforcing agents or filler materials or coloring pigments do not have to be added as such to the polymer melt in the plastic processing plant, and consequently to feed them to an extruder, either a single-or a twin-screw extruder, so-called filled polymer extrudates, usually available in granular form, is used. Such precursors, often also referred to as “master batch”, consist of a polymer, for example polypropylene, in which the reinforcing agents or filler materials or coloring pigments have been added in a high concentration. From these highly filled polymer extrudates, the masterbatch, and by adding further melt-forming components, the so-called “compound” are made in the extruder in the plastic processing plant, which is the finished melt with the reinforcing agents or filler materials or coloring pigments in the desired concentration. One example of such reinforcing agents or filler materials are fibers, more particularly glass fibers, which are available in the final product in the desired concentration, and often also in the desired minimum length. An example of a coloring pigment is an effect pigment, a mica pigment, for example which may be processed in coating an article—in particular o optical reasons—as it shimmers.

It is known how to prepare a filled polymer extrudate as a rod-shaped pellet with glass fibers located in the core of the rod-shaped pellet. For the preparation of such rod-shaped pellets, glass fiber ravings are unwound; the thin fibers are bundled individually and completely coated with the polymer. The individual fibers are in the extrudate strand, or, in the subsequently cut granular rod in the granule core, basically running in parallel. They are completely surrounded by polymer on the outside. While this may allow producing rod-shaped pellets filled with long fibers, which can be further processed in the desired shape and allows to find glass fibers of the desired minimum length in the finished component, as the glass fibers only get in contact with the cylinder wall of the extruder relatively late while melting the rod-shaped pellets in the processing extruder, when they are sheared and consequently comminuted. However, such a method allows processing only such fibers; moreover, specific processing nozzles for bundling and wrapping the fibers are required.

Coloring pigments, particularly in the form of effect pigments, are problematic in handling and processing, as they atomize very easily or especially in the case of effect pigments, which are frequently available in the form of small plates and the like, break easily. For this reason, a known process is tumbling effect pigments onto spherical plastic pellets, so that small globules are generated that have a plastic core inside, and only mechanically adhering pigments outside. If these tumbled granules are added to the extruder, it may occur that they get in contact with the cylinder wail very early and hence get strongly broken as the pigments are outside, so that the actual effect occurring in the final product will no longer be the one desired.

The invention is therefore based on the problem to provide a method which enables the production of different type of filled polymer extrudates.

To solve this problem in a process for preparing a filled polymer extrudate the invention provides for preparing a flowable composition containing a carrier fluid and the added reinforcing agents or filler materials or coloring pigments in a first extruder, and for preparing a polymer melt from a thermoplastic polymer in a second extruder, with the composition and the polymer melt subsequently being co-extruded in a co-extrusion step so that the polymer melt surrounds the composition which forms the core of the extrudate strand generated.

The method defined in the invention provides for the production of a filled polymer extrudate by coextrusion. For this purpose, a fluid composition is prepared in a first extruder. Such fluid composition consists of a carrier fluid, which ensures that the composition is still fluid enough to be conveyed from the extruder to a subsequent coextruder. The desired reinforcing agent or filler material or coloring pigment is added to the carrier fluid as defined by the invention, which is achieved with the application on the first extruder. The location of the application is selected on the extruder depending on the material of the reinforcing agent or filler or the coloring pigment, in order to ensure that the respective reinforcing or filler or the coloring pigment is available in the desired form and mixture. Where reinforcing agents or filler materials are added in the form of fibers or fiber ravings, such addition occurs as late as possible in order to ensure that fiber pieces as long as possible are available in the flowable material. The same applies in the case of effect pigments, which are also added as late as possible to ensure they are stressed as little as possible mechanically when integrated into the carrier fluid. Where insensitive reinforcing agents or filler materials or pigments used, they can be applied earlier.

Thus, independently from this step, a flowable mixture containing a reinforcing agent or filler material or a coloring pigment, preferably in high concentration, also called preparation, is prepared with the first extruder.

In a second extruder working in parallel, a polymer melt is prepared from a thermoplastic polymer which may be polypropylene or any other thermoplastic polymer, which is the basis for the plastic matrix the finally produced plastic-based component is supposed to reveal. Such polymer melt is now also added to the coextruder as provided for in the invention. There, the flowable composition and the polymer melt are now coextruded with one another such that a strand of extrudate is formed, in which the composition is in the extrudate core, while the polymer melt completely surrounds the mass. The ratio of core thickness to shell thickness can of course be adjusted appropriately with the coextrusion nozzle. Thus, there is a coextruded strand consisting of a prepared core with a defined structure and a defined strand shell. The extrudate strand is then crushed either immediately afterwards to form a granule, preferably a rod-shaped pellet, which is effected by appropriate cutting or the like. It would basically be possible as well to wind the extrudate and store it temporarily as a roll in order to crush the strand at some other point in time.

Consequently, the process of the invention allows for the preparation of a polymer extrudate, which has a filled, preferably highly-filled core insertable with virtually any reinforcing agent or filler material or coloring pigment. The reinforcing agents or filler materials or pigments are fully incorporated into the carrier fluid, with the core completely enclosed in the polymer shell. Since the flowable composition is prepared in a separate extruder, it can be manufactured in such an optimized way that the reinforcing agents or filler materials or pigments—although very fragile—are added in an appropriately gentle way so that they are in the extrudate in the desired form, both in terms of length and in terms of quality.

Even any further processing of this filled extrudate can be done in a way to ensure the reinforcing agents or filler materials and pigments respectively are in the finished component in the form requested. Due to the fact that the reinforcing agents or filler materials and pigments respectively are included in the extrudate and surrounded by a sufficiently thick polymer shell, it is ensured that, after applying it in the processing extruder, the polymer shell melts before the reinforcing agents or filler materials or pigments actually get in contact with the cylinder wall or the extruder screws, therefore exposed to mechanical stress. Since this mechanical stress only occurs at a later time, it is ensured that the reinforcing agents or filler materials or pigments do not change their form slightly until final processing by injection molding or the like, and, in the case of fibers, are consequently available in the desired minimum length, or, in the case of effect pigments, are still of sufficient size or the like so that they can have their full effect.

According to the invention, the carrier fluid to be used may be oil or a wax molten in the extruder. The carrier fluid has to be sufficiently liquid to form a sufficiently flowable composition in general, and to allow for the reinforcing agents or filler materials or pigments being distributed homogeneously therein, To this end, innately fluid oil is used, which is already added to the extruder in liquid form. Alternatively, a wax molten only in the extruder can be used as the carrier fluid, For this purpose, the extruder is equipped with appropriate heating elements, which allow melting the wax. The oil or wax forms the binding matrix, in which the reinforcing agents or filler materials and pigments respectively are absorbed, Since the proportion of oil or wax within the flowable composition should preferably be as low as possible, it is perfectly possible to use even such carrier fluids as are still available fluid or soft in the finished extrudate.

Alternatively, the invention also provides for using a thermoplastic polymer as a carrier fluid, molten in the extruder so that there is a polymer matrix both in the extrudate core and in the extrudate shell. In spite of the fact that its share in the composition should be as low as possible when using a polymer as a carrier fluid, this allows to increase the total polymer content in the extrudate a bit. Where a thermoplastic polymer is used as the carrier fluid, such polymer may correspond to the polymer melt forming the polymer, which means that the core material and the shell material are the same. Alternatively, the carrier fluid polymer may differ from the melt polymer.

As already described, reinforcing agents or filler materials as defined in the invention can be used in the form of fibers, in particular in the form of glass fibers. The coloring pigments can be used in the form of powders or platelets with mainly effect pigments available in the form of platelets.

Where reinforcing agents or filler materials such as glass fibers are used, they can already be added to the extruder in a strip form. Conveniently, such feeding occurs in the form of one or several rovings, i.e. endless fiber strands unwound from a roll, which are automatically retracted via a corresponding feed opening such as an opening for atmospheric ventilation, when the screw shafts rotate. Regardless of whether the fibers are added in the form of rovings or cut fibers or cut glass, the fibers are shortened even further in the extruder, so that they are available in the finished composition leaving the extruder and therefore in the extrudate strand in the desired final length, for example, ≧3 mm. in this case, the fibers or roving, and the powder or platelets respectively, are applied to the first extruder at a position which, relating to the length of the working part of the extruder consisting of a cylinder and at least a worm shaft rotating therein, is closer to the end of the working part than to its beginning. This means that the fibers or roving, and the powder or platelets respectively, are applied as late as possible in order to ensure that the mechanical stress experienced in particular by the fibers and the platelets respectively, is as low as possible so that the fibers as well as the platelets may maintain their original shape as long as possible and are distributed as homogeneously as possible in the free-flowing composition and consequently in the core of the extrudate. With respect to the fibers, such feeding is preferably made in a way ensuring that the fibers have a preferred orientation in the flow direction of the composition, which means that they are aligned lengthwise of the strand in the core of the extrudate if possible.

According to the invention, the fibers are processed in the extruder in such a way that they have a length of 2-8 mm in the extrudate strand, in particular 3-5 mm, As mentioned before, this may be adjusted by appropriately choosing the position where the cut fibers or rovings are applied as well as by selecting the appropriate operating parameters, with which the first extruder is operated, and with the appropriate choice of the carrier fluid and its preparation and viscosity.

According to the invention, the proportion of carrier fluid in the composition should be between 5-50% and the share of the reinforcing agent or filler material or pigment in the composition should be 95-50%. The higher the reinforcing agent or filler or pigment content is filled, the higher the flowable composition and the extrudate. Preferably, the share of reinforcing agents or filler materials and pigments respectively is chosen to be as high as possible but it is always important to always make sure that the composition is still sufficiently fluid, which can also be adjusted by the corresponding temperature of the carrier fluid. If possible, the share of reinforcing agents or filler materials or pigments respectively in the carrier fluid and therefore in the core should adjusted in such a quantity that the proportion relating to the entire extrudate is between 50-70%. This means, of course, that the thickness of the polymer shell shall also be adjusted accordingly.

As already described, the invention provides for the extrudate strand subsequently preferably being crushed to produce particular rod-shaped pellets for which an appropriate cutting device or the like is used.

Furthermore, a coextruder is preferably used which enables the generation of multiple extrudate strands to achieve the highest possible throughput. The plurality of extrudate strands can afterwards be easily cut in a joint cutter.

The invention also relates to an extrudate, which is prepared according to the method described. Such extrudate may preferably be a rod-shaped pellet as a further development of the invention.

The invention also relates to a device for performing the process in the described way. Such device comprises a first extruder for producing the flowable mass, a second extruder for producing a polymer melt, as well as a coextruder, with which the two extruders are connected through separate channels leading the composition or the polymer melt, as well as a crushing or winding device following the coextruder.

The two extruders can be arranged parallel to each other, but it is also conceivable to position them at a 90° angle to each other. The channels leading the composition or the polymer melt can further have each separate heating devices in order to control the temperature of the composition and the polymer melt respectively as well, where required, in order to adjust the viscosity for the subsequent co-extruding step if necessary.

The first and/or second extruder is preferably a twin-screw extruder but also other types of extruders can basically be used as long as this guarantees an appropriate integration of the reinforcing agent or filler materials and the pigments respectively in the carrier fluid, and the preparation of the polymer melt is possible as well.

The coextrusion is suitably adapted to generate several extrudate strands, which is achieved with the suitable design of the extrusion nozzle.

Furthermore, a feeder allocated to the first extruder may be provided for roving, for cut fibers or for pigment. A feed device is chosen, which matches the type of reinforcing agent or filler or pigment respectively. Furthermore, a feeder is provided for at the first extruder, in other words a suitable aperture or the like, the feeder conveys to. Such feeding preferably occurs at the first extruder at a position which, based on the length of the working part of the extruder consisting of a cylinder and at least one rotating screw shaft therein is closer to the end of the working part than to the front, The reason for this being to ensure that the fibers and the roving or pigment, either in powder or platelet form are added as late as possible in order to keep the mechanical stress in the first extruder low, It is conceivable, of course, to provide multiple feed ports distributed on the extruder over the length of the working part, so that the corresponding feed port can be selected depending on the reinforcing agent or filler material or pigment to be applied.

Further advantages, features and details of the invention are shown by the execution example described hereinafter as well as in the drawings. They show:

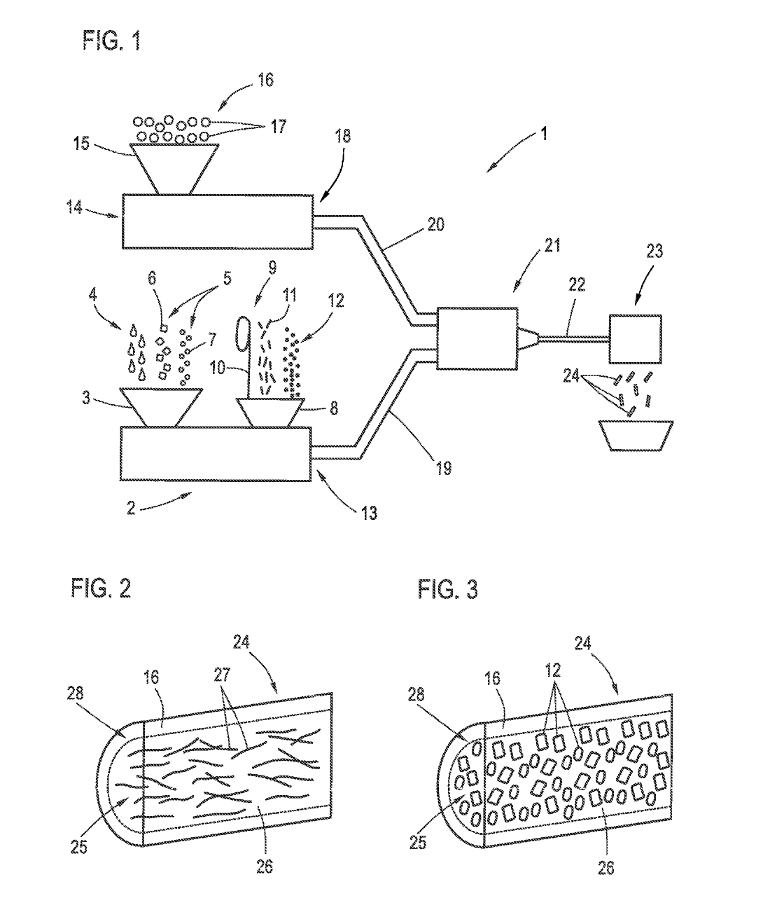

FIG. 1 a schematic diagram of a device defined in the invention for performing the process as defined in the invention,

FIG. 2 a cross-sectional schematic drawing of a first version of an extrudate as defined in the invention, and

FIG. 3 a cross-sectional schematic drawing of a second version of an extrudate as defined in the invention.

FIG. 1 shows device 1 as defined in the invention for producing a filled, particularly highly fined extrudate as defined in the invention, Device 1 comprises a first extruder 2, for example a twin-screw extruder serving to produce a flowable composition composed of a carrier fluid with homogeneously dispersed reinforcing agents or filler materials or pigments respectively. Extruder 2 also includes a first feed 3, through which the agent forming the carrier fluid, and the preparation thereof respectively, is added. An innately fluid agent such as oil 4, as shown by the drop symbol in FIG. 1 can be used as the carrier fluid. Alternatively, a substance in particulate form 5 can be added which is either wax to be molten 6 where the carrier fluid is to be molten wax or polymer particles 7, where the carrier fluid is to be a molten polymer.

Furthermore, a second feed 8 is provided serving the application of a filler or reinforcing material 9, for example in the form of a glass fiber roving 10 or in the form of cut glass 11 (or, of course, fibrous materials other than glass) or of color pigments 12, applied in powder form or in the form of platelets. Evidently, feed 8 is located rather close to the outlet 13 of the extruder, to ensure that the applied reinforcing agent or filler materials 9 or pigments 12 are exposed to the mechanical stress in the extruder 2 for a relatively short time but still long enough in the extruder 2 to ensure that they are homogeneously dispersed and, in the case of the fibers, absorbed aligned in the carrier fluid, irrespective of the material the latter is made of. Extruder 2 has, of course, appropriate heating devices to the carrier fluid either to control the temperature of the carrier fluid, where already added in fluid form, or to melt its initial substance, and basically to lend the flowable composition the corresponding temperature desired.

The amount of applied or generated carrier fluid and applied reinforcing agent or filler material 9 or pigment 12 depends on the intended share of reinforcing agent or filler material 9 or pigment 12 in the flowable composition to be produced and ultimately in the final product to be produced, in this case in the extrudate.

Generally, the amount of carrier fluid in the composition may be between 5-50% and the proportion of reinforcing agents or filler material 9 or pigment 12 in the composition may be 95-50% amount. The higher the proportion of reinforcing agents or flier materials or pigment, the higher the composition filled, the higher the resulting extrudate. Of course, a very high concentration or a high filling level within the mass, which may also be referred to as “preparation”, is preferred.

The device as defined in the invention also comprises a second extruder 14 which is used to produce a polymer melt. It is preferably also designed as a twin-screw extruder and has a feed line 15, via which the initial material 16, here a granulate 17 to be melted and used to produce the polymer melt is applied. It goes without saying that this extruder also has appropriate heating devices to melt the polymer material in connection with the energy input generated by the screw rotation,. The polymer material 16, which is the material of the polymer melt itself, may be the same material as the one in particles 7, which serves for the production of the carrier fluid in the first extruder 2. In this case, a polymer melt loaded with the reinforcing agent or filler material with the pigment is also prepared in the first extruder 2, which is of the same material as the polymer melt produced in the second extruder 14. However, this does not necessarily have to be like this, the two polymers may also differ.

Output 13 of the first extruder 2, and output 18 of the second extruder 14 each have a channel 19, 20, through which the flowable composition (passage 19) and the polymer melt (channel 20) are led from the respective extruder 2, 14 to a coextruder 21. Where required, the two channels 19, 20 may have additional heaters, where the temperature of the mass, or of the polymer melt in the respective channel 19, 20 have to be varied or adjusted.

Coextruder 21 is now designed in such a way and has one or a several corresponding nozzles allowing for the extrusion of an extrusion strand 22 from he composition and the polymer melt, whose core is made of the mass, and the exterior shell is made of the pure polymer melt. So, inside, there is the composition consisting of the carrier fluid and the reinforcing agent or filler material 9 and the pigment 12, the outer casing is made from pure polymer melt. Examples of such an extrudate strand 22 and the individual extrudate pieces in the form of rod-shaped pellets made therefrom are described below in FIGS. 2 and 3.

Extrudate strand 22 is added in the illustrated example to a cutting device 23, which may cut the extrudate strand, for example, using suitable rotating blades or the like 22 to form individual rod-shaped pellets 24. Instead of a cutting device 23, it would also be conceivable first to wind an extrudate strand 22 with a winding device not shown in detail in order to divide it at a later date.

Although the schematic drawing according to FIG. 1 shows a coextruder 21, used to form an extrudate strand 22, it would of course also be conceivable to use a coextruder 21 to a corresponding nozzle arrangement which allows the formation several extrudate strands of identical structure 22, so that a high throughput can be achieved. The individual extrudate strands 22 can, in turn, be cut into a joint cutting device 23 and wound on a joint winding device.

FIG. 2 shows an example of a sectional view of an extrudate in the form of rod-shaped pellets 24. This schematic drawing shows the rod-shaped pellets 24 is shown in longitudinal section. Core 25, consisting of a carrier fluid matrix 26, which consists of the carrier fluid material 6 (wax) or 7 (polymer) re-hardened by then, or —a very small proportion—of the oil 4, which is relatively viscous, and, of course, only has a wetting effect to bind the absorbed reinforcing agents or filler materials and pigments respectively. In the example shown, core 25 further consists of fibers 27, which were formed either from the roving 10, or the cut fibers 11. The roving 10 and the cut fibers 11 respectively have been shortened a bit more by the mechanical stress in the first extruder 2, as a result of the shear at the cylinder wall and of the mechanical stress respectively, so that the length of the fibers 27 is between 2-8 mm, preferably between 3-5 mm. The rod-shaped pellets 24 in the example shown have a length of 20 mm, of course depending on how they are cut in the cutting device 23. As can be seen, the fibers 27 have a rough alignment with the longitudinal axis of the rod-shaped pallets 24, which can be adjusted by setting the appropriate labor and feeding parameters to extruder 2.

Also shown is the outer casing 28 consisting of the polymeric material 16, which is now hardened again. As can be seen, the outer casing 28 completely surrounds the core 25, which means it completely embeds it. Consequently, the fibers 27 are completely encapsulated as well and—when these rod-shaped pellets 24 are melted in another extruder in the course of processing them—first the outer shell 28 is melted until the fibers 27 get in contact with cylinder wall come thus being subjected to mechanical strain. This makes it possible to ensure that in the end product, for example a plastic injection-molded part or of a plastic coating, or the like, the fibers 27 are still available with a sufficient length of fibers.

FIG. 3 shows another example of the rod 24, the rod-shaped pellet. Here again, there is a core 25 consisting of the carrier fluid matrix 26, and in the example shown pigments 12, here provided in the form of platelets, which means effect pigments. Core 25, in turn, is completely surrounded by an outer coat 28 composed of the polymer 16. The pigments in the form of platelets are substantially homogeneously dispersed in core 25, they are still sufficient in size, since they are, as already described for FIG. 1 and also for the fibers in FIG. 2, are added to the extruder 2 a rather a late point in time and hence only undergo a little mechanical stress. Where such rod-shaped pellets 24 are processed in a processing extruder, the outer shell 28 is also melted in this case, which means the polymer is melted first and only afterwards do the pigments 12 and the platelets get in contact with the cylinder wall. This ensures that they also subject to little mechanical stress in the granule processing until they leave the extruder and are transformed into the final product, either by spraying, by coating, etc, Then they are still of reasonable size to supply their optical effect, The carrier fluid matrix 26 may, in turn, be either material 4, 6, or 7.

Although glass fibers and effect pigments in the form of effect platelets are shown in the examples any other reinforcing agents or filler materials or pigments may be added, of course, Fibers can be added from other materials, as well as reinforcing agents or filler materials, which are not in fiber form, may be incorporated homogeneously in core 25. Also, other color or effect pigments may of course be integrated in the pigments described in the form of platelets in core 25. All produced extrudates 22 and rod-shaped pigments 24 have one thing in common, which is the co-extruded two-layered structure consisting of the filled or highly filled core 25 of a reinforcing agent or filler material or a pigment and a carrier fluid matrix and the outer sheath 28 mace of polymer 16

The indicated percentages are percentages by weight each.

1. A process for preparing a filled polymer extrudate, comprising: a first extruding a flowable composition composed of a carrier fluid and reinforcing agents or filler materials, or coloring pigments;
a second extruding a polymer melt of a thermoplastic polymer; and coextruding the composition and the polymer melt in such a way that the polymer melt surrounds the composition generated in the core of the extrudate strand.

2. The process according to claim 1, wherein an oil or a wax molten in the extruder or thermoplastic polymer as the carrier fluid.

3. The process according to claim 2, wherein the polymer forming the carrier fluid corresponds to the polymer forming the polymer melt, or differs from it,

4. The process according to claim 1, wherein the reinforcing agent or filler materials is in the form of fibers, and the coloring pigments are in the form of powder or platelets.

5. The process according to claim 4, wherein a roving is added to the first extruding out of which the fibers are produced in the extruder.

6. The process according to claim 4, wherein the fibers or the roving, or the pigment are applied during the first extruding at a position which, based on the length of the working part of the extruder and consisting of a cylinder and at least one worm shaft rotating therein, is closer to the end of the working part than to the front.

7. The process according to claim 4, wherein the fibers in the extruder are processed such that they reveal a length of 2 to 8 mm, in the extrudate strand.

8. The process according to claim 1, wherein the proportion of carrier fluid in the composition is between 5%-50% and the amount of reinforcing agent or filler or pigment in the composition is 95%-50%.

9. The process according to claim 1, wherein the extrudate strand is then cut in small pieces.

10. The process according to claim 1, wherein the coextruding produces multiple extrudate strands.

11. An extrudate, produced according to the process of claim 1.

12. An extrudate produced according to claim 11, and having a rod-shaped pellet.

13. A device for carrying out the process according to claim 1, comprising:
a first extruder for preparing the flowable composition,
second extruder for preparing the polymer melt, and
a coextruder, through which the two extruders are connected via separate channels leading the composition or the polymer melt, and a grinding or winding-up device subsequent to the coextruder.

14. The device according to claim 13, wherein the first and/or the second extruder is a twin-screw extruder.

15. The device according to claim 13, wherein the coextruder generates a plurality of extrudate strands.

16. The device according to claim 13, wherein a feeding device is provided for a roving, for cut fibers or for pigment allocated to the first extruder. 17, The device according to claim 13, wherein at the first extruder, a feeder for fibers and the roving, or the pigment are provided for at a position which, relating to the length of the working part of the extruder consisting of a cylinder and at least one screw shaft rotating therein is closer to the end of the working part than to its front.
